(19) United States
(12) Patent Application Publication
(10) Pub. No.: US 2007/0233652 A1
(43) Pub. Date: Oct. 4, 2007

(54) System and method for pre-sorting table data

(75) Inventor: Rosen A. Chaushev, Sofia (BG)

Correspondence Address: SAP/BLAKELY, 1279 OAKMEAD PARKWAY, SUNNYVALE, CA, 94085-4040, US

(73) Assignee: SAP AG

(21) Appl. No.: 11/395,680

(22) Filed: Mar. 30, 2006

(51) Int. Cl. G06F 17/30

(52) U.S. Cl. 707/3

(57) ABSTRACT

A system and method are described for efficiently filtering and restoring tables within an enterprise application server. For example, one embodiment of the invention detects that a filtering function has been selected for a particular table node and responsively stores elements from the table node within a backup table collection. The filtering function is then performed to generate a filtered table node containing a subset of elements specified by the filtering function. Subsequently, upon detecting that the filtering function has been disabled, the table node may be restored from the backup table collection.

### BACKGROUND

1. Field of the Invention

This invention relates generally to the field of data processing systems. More particularly, the invention relates to a system and method for implementing accumulative rows within master tables.

2. Description of the Related Art

Multi-Tiered Enterprise Computing Systems

Traditional client-server systems employed a two-tiered architecture such as that illustrated in FIG. 1a. Applications 102 executed on the client side 100 of the two-tiered architecture are comprised of a monolithic set of program code including a graphical user interface component, presentation logic, business logic and a network interface that enables the client 100 to communicate over a network 103 with one or more servers 101. A database 104 maintained on the server 101 provides non-volatile or “persistent” storage for the data accessed and/or processed by the application 102.

The “business logic” component of the application represents the core program code of the application, i.e., the rules governing the underlying business process (or other functionality) provided by the application. The “presentation logic” describes the specific manner in which the results of the business logic are formatted for display on the user interface. The “database” 104 includes data access logic used by the business logic to store and retrieve data.

The limitations of the two-tiered architecture illustrated in FIG. 1a become apparent when employed within a large enterprise. For example, installing and maintaining up-to-date client-side applications on a large number of different clients is a difficult task, even with the aid of automated administration tools. Moreover, a tight coupling of business logic, presentation logic and the user interface logic makes the client-side code very brittle. Changing the client-side user interface of such applications is extremely hard without breaking the business logic, and vice versa. This problem is aggravated by the fact that, in a dynamic enterprise environment, the business logic may be changed frequently in response to changing business rules. Accordingly, the two-tiered architecture is an inefficient solution for enterprise systems.

In response to limitations associated with the two-tiered client-server architecture, a multi-tiered architecture has been developed, as illustrated in FIG. 1b. In the multi-tiered system, the presentation logic 121, business logic 122 and database 123 are logically separated from the user interface 120 of the application. These layers are moved off of the client 125 to one or more dedicated servers on the network 103. For example, the presentation logic 121, the business logic 122, and the database 123 may each be maintained on separate servers, 126, 127 and 128, respectively.

This separation of logical components and the user interface provides a more flexible and scalable architecture compared to that provided by the two-tier model. For example, the separation ensures that all clients 125 share a single implementation of business logic 122. If business rules change, changing the current implementation of business logic 122 to a new version may not require updating any client-side program code. In addition, presentation logic 121 may be provided which generates code for a variety of different user interfaces 120, which may be standard browsers such as Internet Explorer® or Netscape Navigator®.

The multi-tiered architecture illustrated in FIG. 1b may be implemented using a variety of different application technologies at each of the layers of the multi-tier architecture, including those based on the Java 2 Enterprise Edition™ (“J2EE”) standard, the Microsoft .NET standard and/or the Advanced Business Application Programming (“ABAP”) standard developed by SAP AG. For example, as described below, in a J2EE environment, the business layer 122, which handles the core business logic of the application, is comprised of Enterprise Java Bean (“EJB”) components with support for EJB containers. Within a J2EE environment, the presentation layer 121 is responsible for generating servlets and Java Server Pages (“JSP”) interpretable by different types of browsers at the user interface layer 120.

J2EE Application Server Architecture

FIG. 2a illustrates a typical J2EE application server 200 in which the presentation layer is implemented by a “Web container” 211 and the business layer is implemented by an Enterprise Java Bean (“EJB”) container 201. Containers are runtime environments which provide standard common services 219, 209 to runtime components. For example, the Java Naming and Directory Interface (“JNDI”) is a service that provides application components with methods for performing standard naming and directory services. Containers also provide unified access to enterprise information systems 217 such as relational databases through the Java Database Connectivity (“JDBC”) service, and legacy computer systems through the J2EE Connector Architecture (“JCA”) service. In addition, containers provide a declarative mechanism for configuring application components at deployment time through the use of deployment descriptors.

As illustrated in FIG. 2a, each layer of the J2EE architecture includes multiple containers. The Web container 211, for example, is itself comprised of a servlet container 215 for processing servlets and a Java Server Pages (“JSP”) container 216 for processing Java server pages. The EJB container 201 includes three different containers for supporting three different types of enterprise Java beans: a session bean container 205 for session beans, a entity bean container 206 for entity beans, and a message driven bean container 207 for message driven beans. A more detailed description of J2EE containers and J2EE services can be found in RAGAE GHALY AND KRISHNA KOTHAPALLI, SAMS TEACH YOURSELF EJB IN 21 DAYS (2003) (see, e.g., pages 353-376).

Table Processing

The display of data records in tables and forms and the associated editing of the tables and forms (e.g., selecting, deleting, sorting, etc) by clients are central functions in Web-based applications. Thus, various techniques are provided within the J2EE architecture for creating and working with tables in response to client requests. In particular, under a model-view-controller (“MVC”) architecture, illustrated in FIG. 2b, Web-based content using tables may be created within the Web Container 211 using “controllers” 240 and “views” 251-252 that operate in conjunction with “models” 260 within the EJB container 201. A detailed description of the MVC architecture is beyond the scope of the present application but, briefly, the controller 240 manages the underlying table structure and data, referred to in FIG. 2b as a table node 250. The table structure is presented to Web clients 220 in the form of one or more “views” 251-252 which indicate, for example, how the table is presented within a Web page. Controllers may be implemented by servlets and views by Java server pages. The model 260 within the EJB container 201 provides an interface between the controller 240 and the underlying table data stored within the database 123. See, e.g., GHALY and KOTHAPALLI mentioned above for additional detail on the MVC architecture at pages 148-152.

Once the table node 250 is generated, it may be filtered and/or otherwise modified in response to requests from Web clients. For example, as part of a search request a Web client may designate a filtering operation such as “only display client records in the table beginning with the letters DE.” As a result the table node will be filtered and the results provided to the client.

The controller 240 may also generate table structures with hierarchical, parent/child relationships in which each record in a “master” table references a “child” table. This is useful, by way of example, for capturing and displaying product-component relationship in which each product in the master table identifies a set of components associated with the product. The master table and child table may then be displayed side-by-side (according to a specified view 251-252.

FIGS. 2c-d illustrates this behavior using a master parent table 110 which includes a plurality of records which identify different child tables 120, 130. Specifically, Record 1 is associated with child table 120 (containing items 1-3) and Record 2 is associated with child table 130 (containing items 4-6). A view is provided which allows the user to select a particular record from the master table 110 via selection column 112 (e.g., by checking a box in the row corresponding to the record). In response, the corresponding child table is displayed concurrently with the master table 110. Thus, in FIG. 2c, the selection of Record 1 causes child table 120 to be displayed and, in FIG. 2d, the selection of Record 2 causes child table 130 to be displayed.

### SUMMARY

A system and method are described for efficiently filtering and restoring tables within an enterprise application server. For example, one embodiment of the invention detects that a filtering function has been selected for a particular table node and responsively stores elements from the table node within a backup table collection. The filtering function is then performed to generate a filtered table node containing a subset of elements specified by the filtering function. Subsequently, upon detecting that the filtering function has been disabled, the table node may be restored from the backup table collection.

### BRIEF DESCRIPTION OF THE DRAWINGS

A better understanding of the present invention can be obtained from the following detailed description in conjunction with the following drawings, in which:

FIG. 1a illustrates a traditional two-tier client-server architecture.

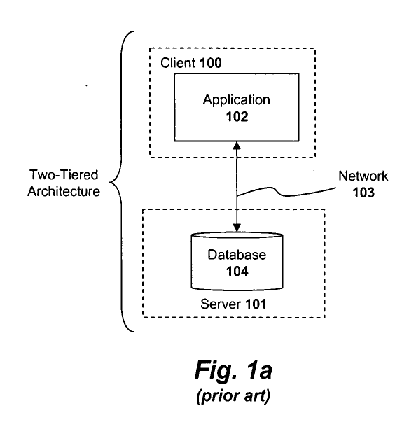

FIG. 1b illustrates a prior art multi-tier client-server architecture.

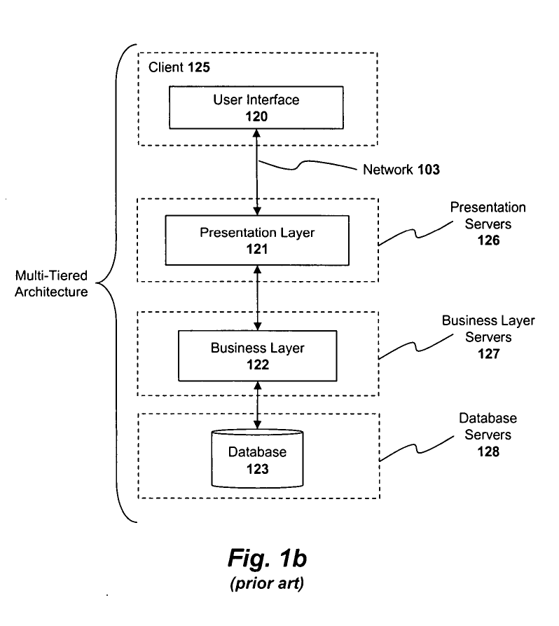

FIG. 2a illustrates a multi-tiered application server architecture according to the Java 2 Enterprise Edition (“J2EE”) standard.

FIG. 2b illustrates a model view controller (“MVC”) architecture implemented within a J2EE architecture.

FIG. 2c-d illustrate parent/child table relationships used in prior art computing systems.

FIG. 3 illustrates one embodiment of a system for efficiently filtering and restoring tables within an enterprise network.

FIG. 4 illustrates one embodiment of a method for efficiently filtering and restoring tables within an enterprise network.

FIG. 5 illustrates a view of a master table including a cumulative row and a cumulative child table according to one embodiment of the invention.

FIG. 6 illustrates an architecture for creating a cumulative record and a cumulative child table according to one embodiment of the invention.

FIG. 7 illustrates a cumulative data module according to one embodiment of the invention.

FIG. 8 illustrates a process for associating items with a cumulative record according to one embodiment of the invention.

FIG. 9 illustrates a method for updating the association of items with records according to one embodiment of the invention.

FIG. 10 illustrates a method for allowing the display of all items or only unique items according to one embodiment of the invention.

FIG. 11 illustrates a pre-sort module for pre-sorting tables according to one embodiment of the invention.

FIG. 12 illustrates an attribute comparator employed within the pre-sort module according to one embodiment of the invention.

FIG. 13 illustrates a system architecture according to one embodiment of the invention.

### DETAILED DESCRIPTION OF PREFERRED EMBODIMENTS

Described below is a system and method for performing various operations on tables. Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Table Filtering Embodiments

One embodiment of the invention saves the elements of the table node in a backup table collection in response to detecting a table filtering operation. Subsequently, when the filtering operation is switched off, the table node is restored from the backup collection rather than being regenerated from scratch and wasting processing resources and bandwidth.

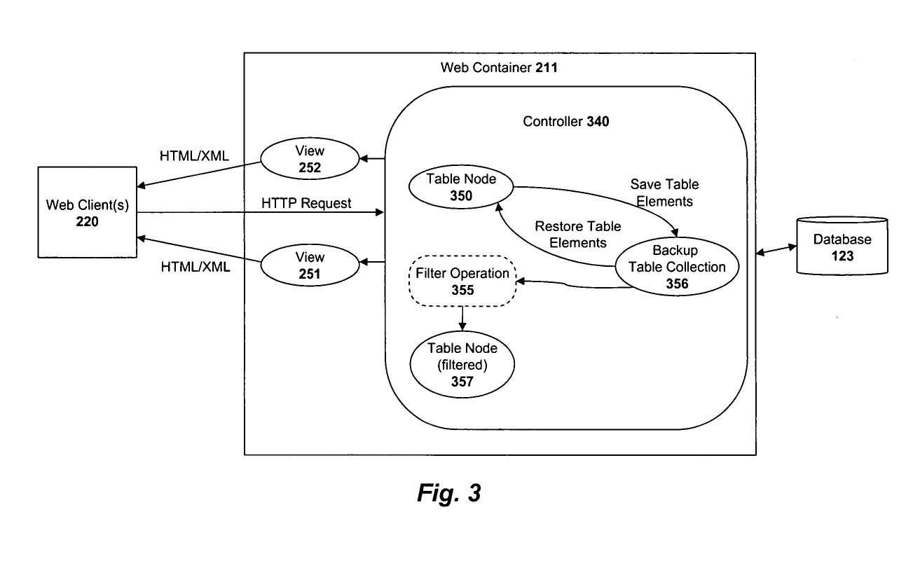

FIG. 3 illustrates one embodiment of the invention which addresses the foregoing limitations. In this embodiment, in response to detecting a filtering operation on data stored within a table node 250 (i.e., turning on the filter in response to a request from a client 220), a backup table collection 356 is generated. In one embodiment, the backup table collection 356 includes all of the table elements contained within the table node 350.

The filtering operation 355 designated by the client 220 may then be performed on the backup table collection 356 to generate a filtered table node 357. A virtually unlimited number of filtering operations may be performed to generate the table node 357. For example, as mentioned above, a user may specify a certain date range for records within the table, or may indicate a certain sequence of characters (e.g., the letters “DR”).

In one embodiment, the filtering operation is not performed directly on the backup table collection 356 but, rather, is performed directly on the table node 350. In either case, the backup table collection 356 is maintained in memory so that it can be used to reconstruct the table node 350 if necessary.

Regardless of how it is generated, the filtered table node 357 may then be provided to the requesting client 220 according to a specified view 251, 252 (e.g., as a user-navigable table embedded within a Web page).

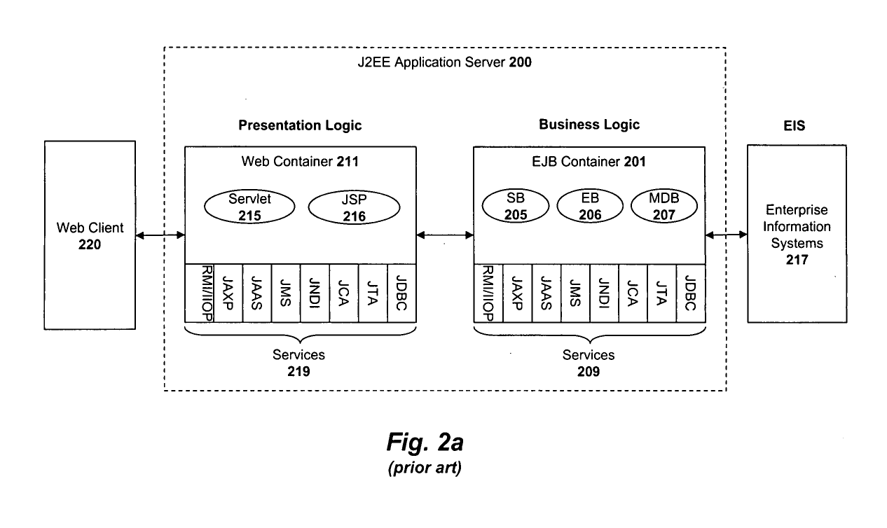

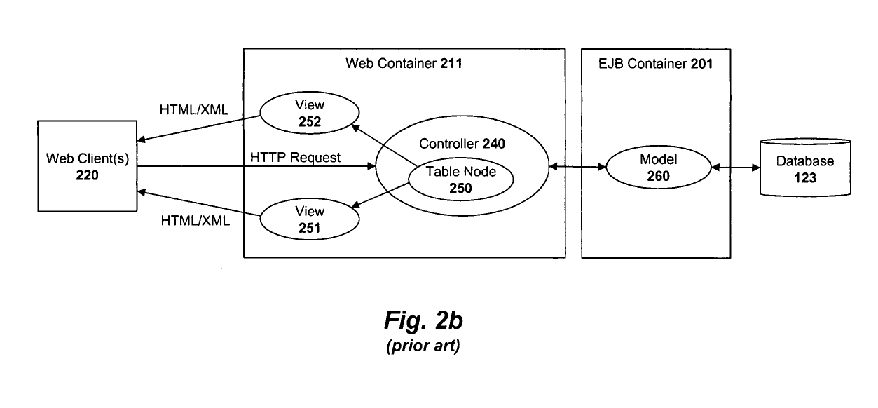

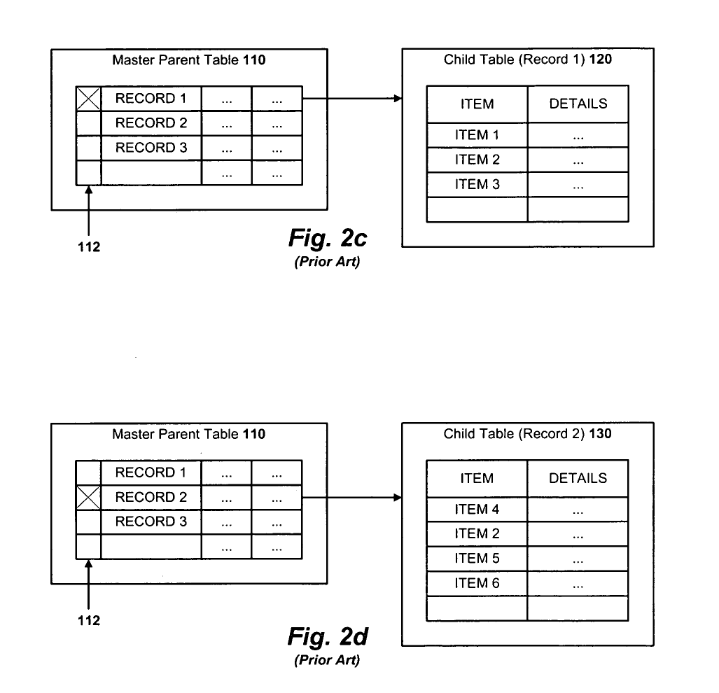

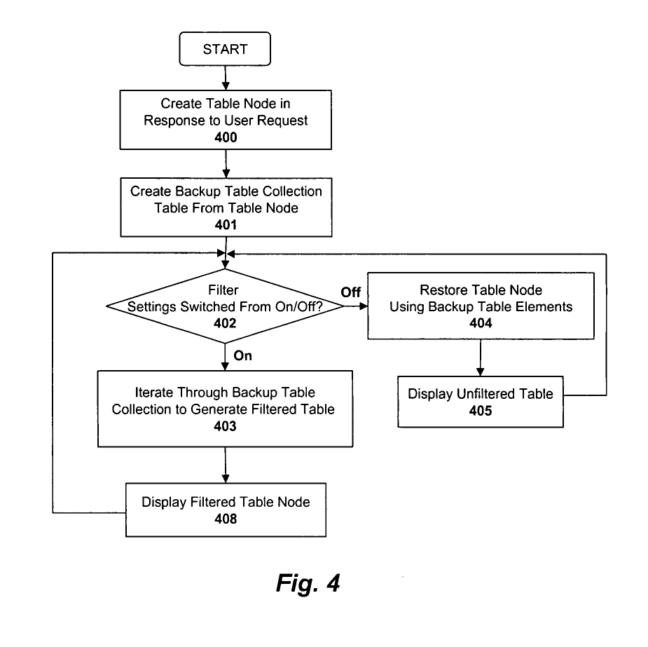

FIG. 4 illustrates a method for performing filtering operations on tables and/or table data according to one embodiment of the invention. At 400 a table node 350 is created in response to a user request (e.g., an HTTP request from a Web browser). To generate the table node 350 data may be retrieved from the central database 123 and embedded within the table node 350 (e.g., via a “model” component within the business layer as indicated in FIG. 2b). At 401, a backup table collection 356 is created from table node 350. In one embodiment, the backup table collection 356 is created in response to a user-initiated implementation of a filtering function (e.g., a user specifying filtering criteria via a Web browser or other graphical user interface).

At 402 a determination is made as to whether the filter settings are being switched from ‘on’ to ‘off’ or from ‘off’ to ‘on.’ If the filter settings are switched from ‘off’ to ‘on,’ then at 403 a filtered table node 357 is generated by iterating through each element in the backup table collection 356 and comparing the element with the specified filtering criteria. Elements which match the filtering criteria are copied to the filtered table node 357. A specified view 251, 252 containing the filtered data may then be generating for the end user. When the last element in the backup table collection 356 is reached, the filtered table node 357 is complete.

If, at 402, the filter settings are switched from ‘on’ to ‘off,’ then the unfiltered table node 350 is restored from the backup table collection 356. IN particular each element within the backup table collection is coped to the table node 350. Consequently, the original table node 350 is restored without use of the supply functions.

Cumulative Row/Record Embodiments

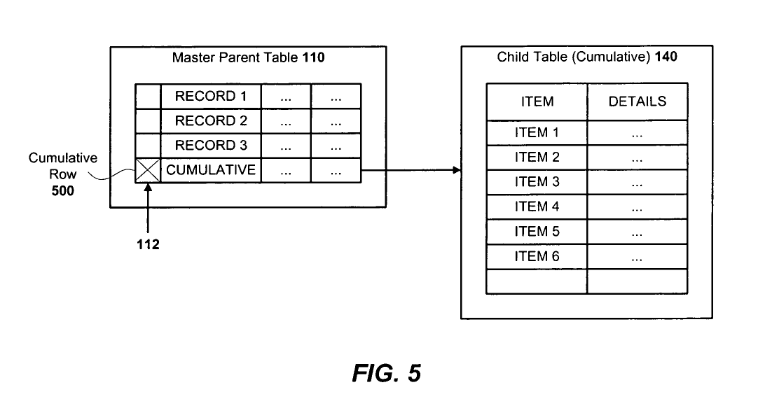

FIG. 5 illustrates a table view according to one embodiment of the invention in which a cumulative row/record 500 is generated for each master table 510. The cumulative row is associated with a cumulative child table 520 containing a complete set of all items from all records in the master table 510. Thus, in one embodiment, to display a complete list of the items associated with the master table, a user only need to select the cumulative row 500 (e.g., by placing a check within the selection column 512 via a mouse or other cursor control device.

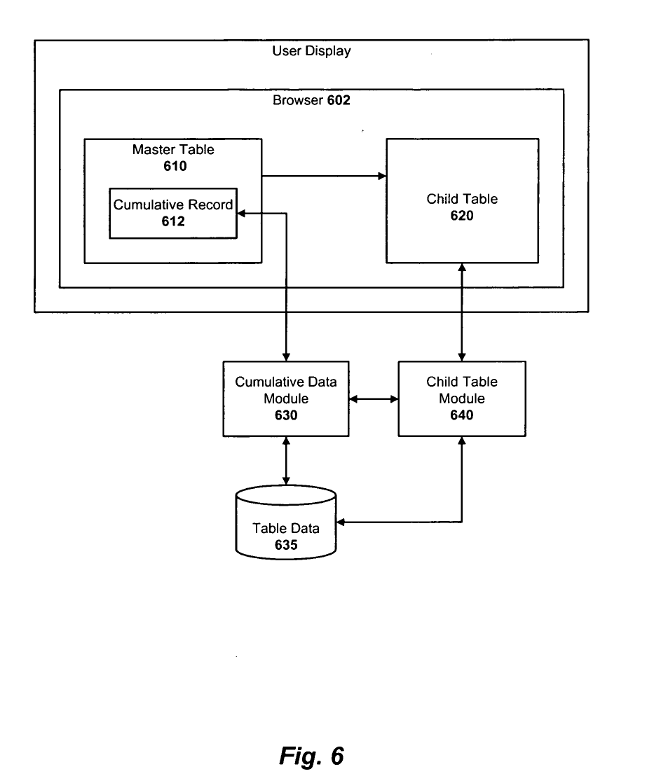

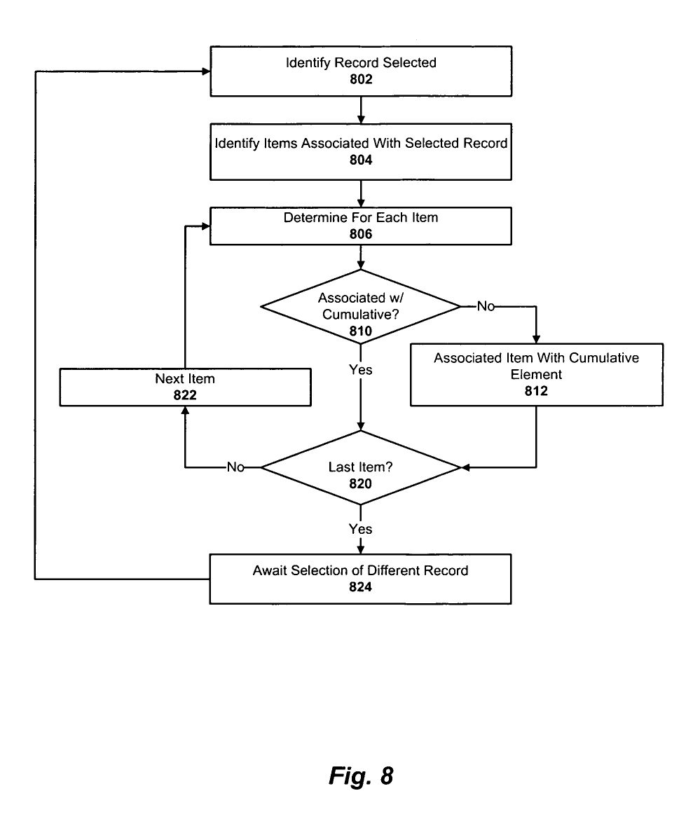

FIG. 6 illustrates one embodiment of an architecture for generating cumulative rows within master tables and/or cumulative child tables. Specifically, a cumulative data module 630 is illustrated which operates on table data from a database 635 to identify the set of items to be used within the cumulative child table 620 (e.g., by executing the methods described below with respect to FIGS. 8-10). In one embodiment, the cumulative data module 630 provides the cumulative set of items to a child table module 640 which responsively formats the cumulative set of items into a specified view for the child table 620. In addition, in one embodiment, the cumulative data module generates the cumulative row 612 within the master table 610 and associates the cumulative row 612 with the cumulative child table 620. In one embodiment, both the cumulative data module 630 and the child table module 640 form part of the “controller” layer of a Web container and the master table 610 (including the cumulative row 612) and the child table 620 form part of the “view” layer of the Web container (which may then be displayed within a browser 602).

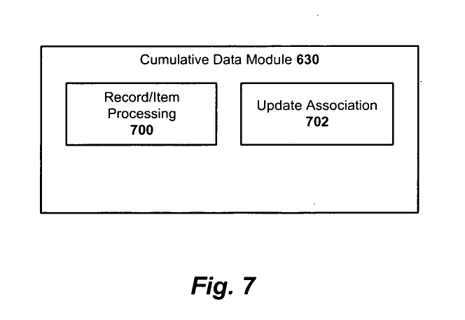

As illustrated in FIG. 7, one embodiment of the cumulative data module 630 includes record/item processing logic 700 and update association logic 702. The record/item processing logic 700 identifies each of the records and items for a given master table to be used within the cumulative child table. For example, the item/record processing logic 700 may either generate a set of all items associated with all records of a master table or, alternatively, may generate a set containing only unique items. The update association logic 702 automatically modifies the association between the items within the cumulative table and/or the master table records in response to table modifications (e.g., item deletions, additions, modifications, etc). Additional details of the operations performed by these modules in one embodiment of the invention are described below with respect to FIGS. 8-10.

FIG. 8 illustrates one embodiment of a method for generating a cumulative child table containing only unique items. At 802, a record within a specified master table is identified and, at 804, the items associated with the record are identified. For example, in one embodiment, the record/item processing logic 700 queries the database to identify the records and associated items. At 806, the process initiates a loop in which a determination is made, at 810, as to whether each item is already associated with the cumulative record 500 within the master table 510. If not, then at 812 the item is associated with the cumulative record 500 and added to the cumulative child table 620 (e.g., by the child table module 640). If the item has already been associated with the cumulative record 500 (e.g., during the processing of a previous record which included the item), then at 820, a determination is made as to whether the item is the last item of the presently-selected record. If not, then the next item is selected at 422 and the process returns to 806. If the item is the last item in the current record, then the process awaits the selection of the next record at 824 and repeats from 802 upon selection of the next record.

In one embodiment, the selection of each of the records for each master table is done automatically performed automatically by the record/item processing logic 700. Alternatively, the selection of each of the records may be performed manually by the end user (e.g., as the user is browsing through the various records of the master table).

The end result of the process shown in FIG. 8 is that a non-duplicative set of items is gathered for the cumulative child table 540 and associated with the cumulative record 500 of the master table 510.

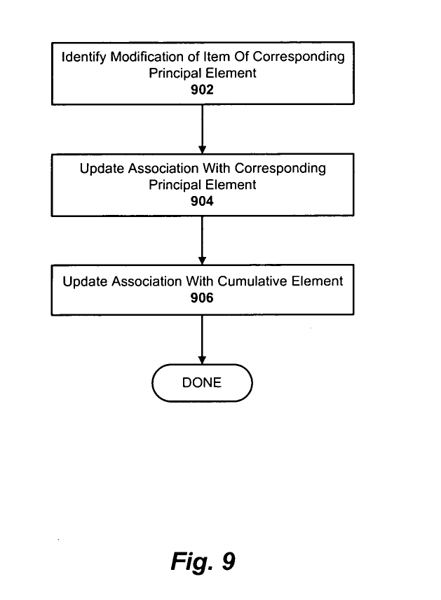

FIG. 9 illustrates one embodiment of a process for updating the master table 510 in response to an operation performed on an item associated with one or more of the records of the master table. An operation may include, for example, the deletion, addition or modification of an item. In one embodiment, the process shown in FIG. 9 is implemented by the update association logic 702 mentioned above.

At 902, an operation associated with a principal record (i.e., a non-cumulative record) is detected by the update association logic 702. For example, a new item may be added to an existing principal record or an old item may be deleted from the existing record. At 904, the association between the item and the principal record is updated. For example, if a new item is added, then the new item is associated with the principal record. Conversely, if an item is deleted, then the association between the item and the principal record is removed. This information may also be updated within the database 635 containing the table data. At 906, the association between the item and the cumulative element is updated. In one embodiment, operation 906 is implemented via the process shown in FIG. 8, or portions thereof. For example, if a new item is added, a determination is made as to whether the item is already associated with the cumulative record. If so, then no modification to the cumulative record is required. If not, then the new item is added to the cumulative record. Conversely, if an item is removed from a record, then a determination is made as to whether that item is still associated with another record. If so, then the item remains associated with the cumulative record. If not, then the item is unassociated from the cumulative record. Thus, modifications to records within the master table are automatically reflected within the cumulative record.

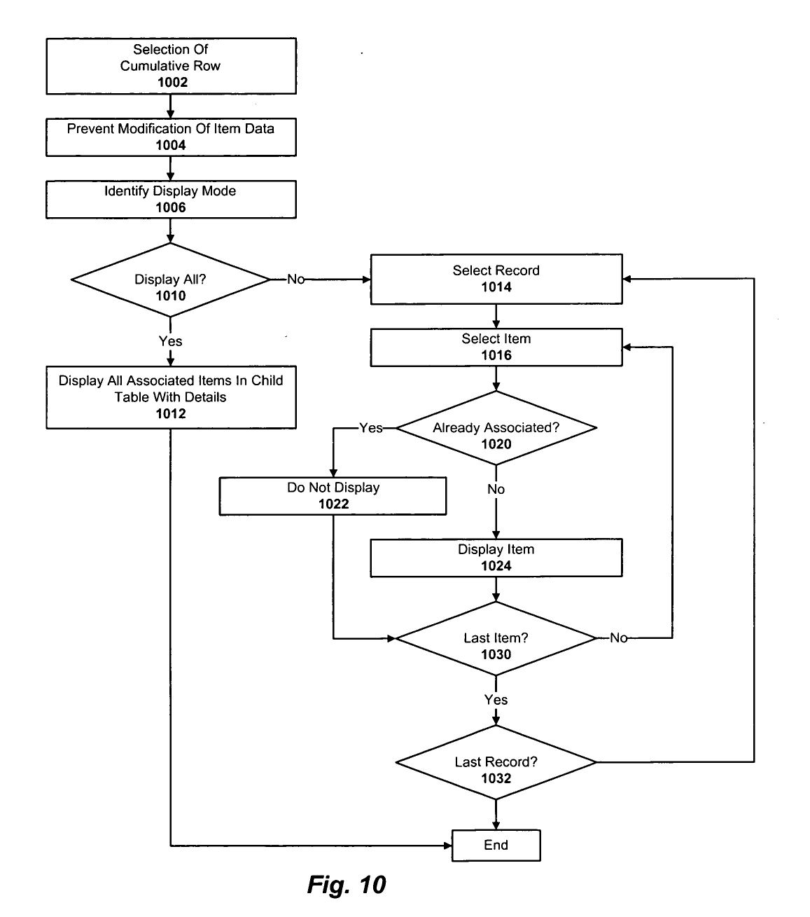

FIG. 10 illustrates an embodiment which includes a selectable view option allowing the user to view all items or only unique items upon selecting the cumulative row. At 1002, the cumulative row is selected (e.g., by placing a check in the selection column via a cursor control device). At 1004, the user is prevented from modifying items from the cumulative child table. One reason for this is that the items displayed may be associated with more than one primary record. Consequently, the modification from the cumulative view will cause all records to be affected (which may not be desirable).

At 1006, the display mode is identified. In one embodiment, the two possible display modes are “display all items” and “display unique items.” If “display all items” is the current mode, determined at 1010, then at 1012 all associated items are displayed in the cumulative child table—even duplicate items from multiple records. In one embodiment, this involves reading each item from each record and associating it with the cumulative record 612 of the master table 610.

If, however, “display unique items” is the current view mode, then each record is selected at 1014 and each item is selected at 1016 and a determination is made at 1020 as to whether the item is already associated with the cumulative child table. If so, then the current item is not displayed at 1022 (e.g., because a duplicate from another record already exists). If not, then at 1024 the item is associated with the cumulative record and displayed within the cumulative child table. When the final item is reached, determined at 1030, and the final record is reached, determined at 1032, then the process ends and the child table is complete (and populated with unique items).

Initial Sorting of Table Elements

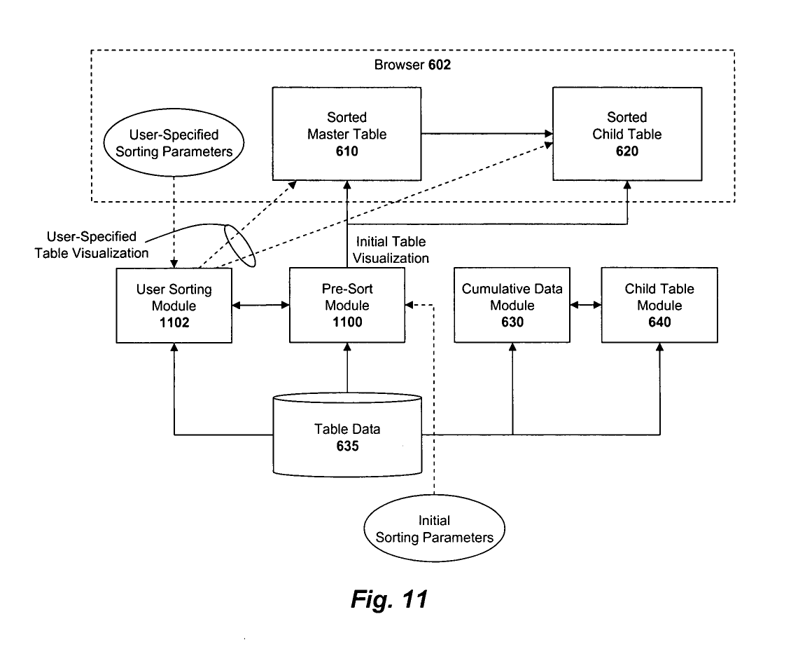

One embodiment of the invention automatically sorts table data according to a set of initial sorting parameters the first time that a table is visualized. Specifically, as illustrated in FIG. 11, this embodiment includes a pre-sort module 1100 for automatically sorting data stored in the master table 610 and/or one or more child tables 620 based on a set of initial sorting parameters—i.e., prior to receiving an explicit request from a user to sort the data.

In one embodiment, after the table is viewed for the first time, a user sorting module 1102 is employed to sort the table data for the master table 610 and/or the child tables 620 based on a set of user-specified sorting parameters. That is, once a user has specified sorting parameters, the user sorting module 1102 takes precedence over the pre-sort module 1100.

By way of example, the initial sorting parameters may specify that the master and/or child tables are to be sorted alphabetically (e.g., based on the record/item name) while the user-specified sorting parameters may specify that the master and/or child tables are to be sorted based on a date associated with the record/item (e.g., the creation date, the last modified date, etc). Thus, when the tables are initially visualized, the records/items are sorted alphabetically. Subsequently, in response to user input, the tables are rearranged based on date. Various other record/item attributes may be used by the pre-sort module 1100 and the user sorting module 1102 to sort the records/items within each table (e.g., sequence number, length of time in inventory, sale date, etc).

In one embodiment, the pre-sort module 1100 selects the attributes used to sort the records/items based on the record/item type. For example, certain types of records (e.g., products) may be automatically sorted alphabetically whereas other types of records (e.g., new orders) may initially be sorted based on the time/date. Other variables may be evaluated by the pre-sort module 1100 when initially sorting the table data including, for example, the work context under which the records/items were requested and/or a historical context under which the data objects were previously requested.

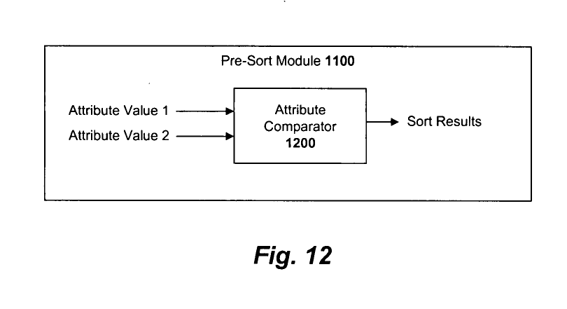

As illustrated in FIG. 12, in one embodiment, the pre-sort module 1100 includes an attribute comparator module 1200 for performing the sorting operations described above. Specifically, once the sorting parameters have been identified, the attribute comparator compares the attributes identified by the sorting parameters for each record/item and generates the sorting results accordingly. By way of example, the first two records/items may be compared and ordered based on the comparison, the next record/item is compared against the first two to determine its place in relation to the first two. This process continues until the last record/item is reached and its place within the tables identified. Various algorithms may be employed to efficiently sort each of the records/items based on attribute values including, for example, Bubble Sorting; Shaker Sorting; B-Tree sorting; and Quicksort (developed by C. A. R. Hoare). The underlying principles of the invention are not limited to any particular sorting algorithm.

The following is an exemplary code sample illustrating how a group of product records may be sorted by name. In this example, “Product” is a node in a context with cardinality (0 . . . n) and has a “Name” attribute.

```
          public void
onActionSortID(com.sap.tc.webdynpro.progmodel.api.IWDCustomEvent
wdEvent )
  {
    if (wdContext.nodeProduct( ) != null ){
      wdContext.nodeProduct( ).sortElements(new Comparator( )
{
          public int compare(Object o1, Object o2) {
            IWDNodeElement element1 = (IWDNodeElement) o1;
            IWDNodeElement element2 = (IWDNodeElement) o2;
            String attributeValue1 =
element1.getAttributeAsText(“Name”);
            String attributeValue2 =
element2.getAttributeAsText(“Name”);
            return
attributeValue1.compareToIgnoreCase(attributeValue2);
          }
        }
      );
    }
  }
```

In one embodiment, the following method (“wdDoModifyView”) is a standard entry point for changing the view so the initially sorted action is invoked there:

```
          public static void
wdDoModifyView(IPrivateNewInstalledProductCompView wdThis,
IPrivateNewInstalledProductCompView.IContextNode wdContext,
com.sap.tc.webdynpro.progmodel.api.IWDView view, boolean
firstTime)
  {
    if (firstTime) {
      wdThis.onActionSortID(null);
    }
  }
```

An Exemplary System Architecture

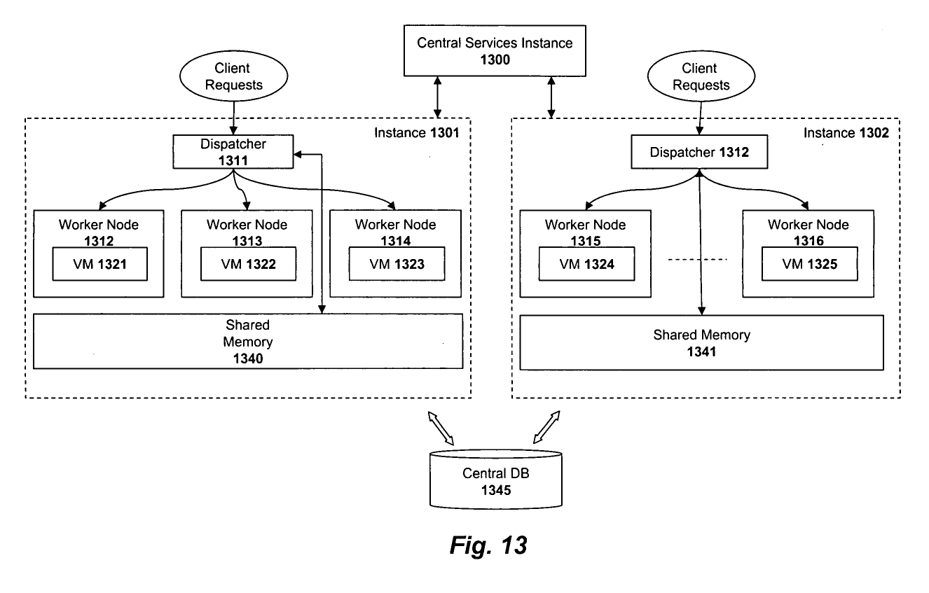

A system architecture on which embodiments of the invention may be implemented is illustrated in FIG. 13. The architecture includes a plurality of application server “instances” 1301 and 1302. The application server instances 1301 and 1302 each include a group of worker nodes 1312-1314 and 1315-1316 (also sometimes referred to herein as “server nodes”), respectively, and a dispatcher 1311 and 1312, respectively. The application server instances 1301, 1302 communicate through a central services instance 1300 using message passing. In one embodiment, the central services instance 1300 includes a locking service and a messaging service (described below). The combination of all of the application server instances 1301 and 1302 and the central services instance 1300 is referred to herein as a “cluster.” Although the following description will focus solely on instance 1301 for the purpose of explanation, the same principles apply to other instances within the cluster.

The worker/server nodes 1312-1314 within instance 1301 provide the business and presentation logic for the network applications supported by the system including, for example, the Web container 211 and the EJB container functionality describe herein. Each of the worker nodes 1312-1314 within a particular instance may be configured with a redundant set of programming logic and associated data, represented as virtual machines 1321-1323 in FIG. 13. In one embodiment, the dispatcher 1311 distributes service requests from clients to one or more of the worker nodes 1312-1314 based on the load on each of the servers. For example, in one embodiment, the dispatcher maintains separate queues for each of the 1312-1314 in a shared memory 1340. The dispatcher 1311 fills the queues with client requests and the worker nodes 1312-1314 consume the requests from each of their respective queues. The client requests may be from external clients (e.g., browser requests) or from other components/objects within the instance 1301 or cluster.

In one embodiment, the worker nodes 1312-1314 may be Java 2 Enterprise Edition (“J2EE”) worker nodes which support Enterprise Java Bean (“EJB”) components and EJB containers (at the business layer) and Servlets and Java Server Pages (“JSP”) (at the presentation layer). In one embodiment, JSPs are used to implement the different views 251 and 252, and servlets are used to implement the controllers 340 illustrated in FIG. 3. In this embodiment, the virtual machines 1321-1325 implement the J2EE standard (as well as the additional non-standard features described herein). It should be noted, however, that certain high-level features described herein may be implemented in the context of different software platforms including, by way of example, Microsoft .NET platforms and/or the Advanced Business Application Programming (“ABAP”) platforms developed by SAP AG, the assignee of the present application.

In one embodiment, communication and synchronization between each of the instances 1301, 1302 is enabled via the central services instance 1300. As mentioned above, the central services instance 1300 includes a messaging service and a locking service. The message service allows each of the servers within each of the instances to communicate with one another via a message passing protocol. For example, messages from one server may be broadcast to all other servers within the cluster via the messaging service (e.g., such as the cache configuration messages described below). Alternatively, messages may be addressed directly to specific servers within the cluster (i.e., rather than being broadcast to all servers). In one embodiment, the locking service disables access to (i.e., locks) certain specified portions of configuration data and/or program code stored within a central database 1345. The locking service locks data on behalf of various system components which need to synchronize access to specific types of data and program code. In one embodiment, the central services instance 1300 is the same central services instance as implemented within the Web Application Server version 6.3 and/or 6.4 developed by SAP AG. However, the underlying principles of the invention are not limited to any particular type of central services instance.

In addition, unlike prior systems, one embodiment of the invention shares objects across virtual machines 1321-1325. Specifically, in one embodiment, objects such as session objects which are identified as “shareable” are stored within a shared memory region 1340, 1341 and are made accessible to multiple virtual machines 1321-1325. Creating new object instances from scratch in response to client requests can be a costly process, consuming processing power and network bandwidth. As such, sharing objects between virtual machines as described herein improves the overall response time of the system and reduces server load.

In a shared memory implementation, a shared memory area 1340, 1341 or “heap” is used to store data objects that can be accessed by multiple virtual machines 1321-1325. The data objects in a shared memory heap should generally not have any pointers or references into any private heap (e.g., the private memory regions/heaps of the individual virtual machines). This is because if an object in the shared memory heap had a member variable with a reference to a private object in one particular virtual machine, that reference would be invalid for all the other virtual machines that use that shared object.

More formally, this restriction can be thought of as follows: For every shared object, the transitive closure of the objects referenced by the initial object should only contain shared objects at all times. Accordingly, in one implementation of the invention, objects are not put into the shared memory heap by themselves—rather, objects (such as the session objects described herein) are put into the shared memory heap in groups known as “shared closures.” A shared closure is an initial object plus the transitive closure of all the objects referenced by the initial object.

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, although many of the embodiments set forth above relate to a Java or J2EE implementation, the underlying principles of the invention may be implemented in virtually any enterprise networking environment. Moreover, although some of the embodiments set forth above are implemented within a shared memory environment, the underlying principles of the invention are equally applicable to a non-shared memory environment. Finally, it should be noted that the terms “client” and “server” are used broadly to refer to any applications, components or objects which interact via remote method invocations.

Accordingly, the scope and spirit of the invention should be judged in terms of the claims which follow.

What is claimed is:

1. A method for initializing a data view, comprising:
receiving a request for a view of multiple data objects;
retrieving the data objects from a database in an arbitrary order;
sorting the data objects according to a sorting function, in response to receiving the request for the data objects, and prior to receiving an explicit request to sort the data objects; and
providing a sorted view of the data objects as an initial view in response to the request for the view.

2. The method of claim 1 wherein sorting the data objects according to the sorting function further comprises:
selecting the sorting function based at least in part on a type of the data objects.

3. The method of claim 2 wherein sorting the data objects according to a sorting function comprises:
sorting the data objects according to at least one of a numeric order, an alphabetic order, or an order of priority.

4. The method of claim 1 wherein sorting the data objects according to the sorting function further comprises:
selecting the sorting function based at least in part on pre-selected preferences for the view.

5. The method of claim 1 wherein sorting the data objects according to the sorting function further comprises:
selecting the sorting function based at least in part on a work context under which the data objects were requested.

6. The method of claim 5 wherein selecting the sorting function based on the work context comprises:
selecting the sorting function based at least in part on a historical context under which the data objects were previously requested.

7. The method of claim 1 wherein providing the sorted view comprises:
populating a table with the data objects in a sorted order.

8. The method as in claim 1 further comprising:
receiving a user request to sort the data objects according to a specified attribute of the data objects;
re-sorting the data objects according to the specified attribute; and
providing a re-sorted view of the data objects.

9. A system for initializing a data view comprising a memory for storing program code, and a processor for processing the program code, the program code, when executed by the processor, causing the processor to perform the operations of:
a pre-sort module to receive a request for a view of multiple data objects;
retrieving the data objects from a database in an arbitrary order;
sorting the data objects according to a sorting function, in response to receiving the request for the data objects, and prior to receiving an explicit request to sort the data objects; and
providing a sorted view of the data objects as an initial view in response to the request for the view.

10. The system of claim 9 wherein sorting the data objects according to the sorting function further comprises:
selecting the sorting function based at least in part on a type of the data objects.

11. The system of claim 10 wherein sorting the data objects according to a sorting function comprises:
sorting the data objects according to at least one of a numeric order, an alphabetic order, or an order of priority.

12. The system of claim 9 wherein sorting the data objects according to the sorting function further comprises:
selecting the sorting function based at least in part on pre-selected preferences for the view.

13. The system of claim 9 wherein sorting the data objects according to the sorting function further comprises:
selecting the sorting function based at least in part on a work context under which the data objects were requested.

14. The system of claim 13 wherein selecting the sorting function based on the work context comprises:
selecting the sorting function based at least in part on a historical context under which the data objects were previously requested.

15. The system of claim 9 wherein providing the sorted view comprises:
populating a table with the data objects in a sorted order.

16. The system as in claim 1 comprising additional program code which, when executed by the processor, causes the processor to perform the additional operations of:
receiving a user request to sort the data objects according to a specified attribute of the data objects;
re-sorting the data objects according to the specified attribute; and
providing a re-sorted view of the data objects.

17. A machine-readable medium having program code stored thereon which, when executed by a machine, causes the machine to perform the operations of:
receiving a request for a view of multiple data objects;
retrieving the data objects from a database in an arbitrary order;
sorting the data objects according to a sorting function, in response to receiving the request for the data objects, and prior to receiving an explicit request to sort the data objects; and
providing a sorted view of the data objects as an initial view in response to the request for the view.

18. The machine-readable medium of claim 17 wherein sorting the data objects according to the sorting function further comprises:
selecting the sorting function based at least in part on a type of the data objects.

19. The machine-readable medium of claim 18 wherein sorting the data objects according to a sorting function comprises:
sorting the data objects according to at least one of a numeric order, an alphabetic order, or an order of priority.

20. The machine-readable medium of claim 17 wherein sorting the data objects according to the sorting function further comprises:
selecting the sorting function based at least in part on pre-selected preferences for the view.

21. The machine-readable medium of claim 17 wherein sorting the data objects according to the sorting function further comprises:
selecting the sorting function based at least in part on a work context under which the data objects were requested.

22. The machine-readable medium of claim 21 wherein selecting the sorting function based on the work context comprises:
selecting the sorting function based at least in part on a historical context under which the data objects were previously requested.

23. The machine-readable medium of claim 17 wherein providing the sorted view comprises:
populating a table with the data objects in a sorted order.

24. The machine-readable medium as in claim 17 comprising additional program code to cause the machine to perform the operations of:
receiving a user request to sort the data objects according to a specified attribute of the data objects;
re-sorting the data objects according to the specified attribute; and
providing a re-sorted view of the data objects.
